(19) United States
(12) Patent Application Publication
(10) Pub. No.: US 2016/0179311 A1
(43) Pub. Date: Jun. 23, 2016

(54) METHOD AND SYSTEM FOR E-BOOK START-READING INTERFACE

(71) Applicant: KOBO INCORPORATED, Toronto (CA)

(72) Inventors: Inae HEO, North York (CA); Benjamin LANDAU, Toronto (CA)

(73) Assignee: KOBO INCORPORATED, Toronto (CA)

(21) Appl. No.: 14/575,988

(22) Filed: Dec. 18, 2014

(51) Int. Cl. G06F 3/0483; G06F 3/0488; G06F 3/041

(52) U.S. Cl. CPC G06F 3/0483; G06F 3/041; G06F 3/0488

(57) ABSTRACT

A method and system for navigating e-book content (e-reading) via a start-reading interface on a computer device having a touchscreen display. The method comprises accessing an e-book stored in the memory, the e-book having digitally constructed pages arranged in an ordered sequence of a cover page, a cluster of precursor pages and a set of substantive-content pages; receiving a page transition event at the cover page displayed on the display screen; and in response to the page transition event, transitioning past the cluster of precursor pages to display a first page of the set of substantive-content pages in replacement of the cover page at the display screen.

### TECHNICAL FIELD

Examples described herein relate to a system and method for operating a computing device in navigating e-book content for digital reading (e-reading).

### BACKGROUND

An electronic personal display is a mobile computing device that displays information to a user. While an electronic personal display may be capable of many of the functions of a personal computer, a user can typically interact directly with an electronic personal display without the use of a keyboard that is separate from, or coupled to, but distinct from the electronic personal display itself. Some examples of electronic personal displays include mobile digital devices/tablet computers and electronic readers (e-readers) such (e.g., Apple iPad®, Microsoft® Surface, Samsung Galaxy Tab® and the like), handheld multimedia smartphones (e.g., Apple iPhone®, Samsung Galaxy S®, and the like), and handheld electronic readers (e.g., Amazon Kindle®, Barnes and Noble Nook®, Kobo Aura HD, Kobo Aura H2O, Kobo GLO and the like).

Some electronic personal display devices are purpose built devices designed to perform especially well at displaying digitally stored content for reading or viewing thereon. for example, a purpose build device may include a display that reduces glare, performs well in high lighting conditions, and/or mimics the look of text as presented via actual discrete pages of paper. While such purpose built devices may excel at displaying content for a user to read, they may also perform other functions, such as displaying images, emitting audio, recording audio, and web surfing, among others.

Electronic personal displays are among numerous kinds of consumer devices that can receive services and utilize resources across a network service. Such devices can operate applications or provide other functionality that links a device to a particular account of a specific service. For example, the electronic reader (e-reader) devices typically link to an online bookstore, and media playback devices often include applications that enable the user to access an online media electronic library (or e-library). In this context, the user accounts can enable the user to receive the full benefit and functionality of the device.

Yet further, such devices may incorporate a touch screen display having integrated touch sensors and touch sensing functionality, whereby user input commands via touch-based gestures are received thereon.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description of the drawings should not be understood as being drawn to scale unless specifically noted.

FIG. 1 illustrates a system utilizing applications and providing e-book services on a computing device configured for navigating e-book content via a start-reading interface for e-reading, in an embodiment.

FIG. 2 illustrates a schematic architecture and configuration of a computing device configured for navigating e-book content via a start-reading interface for e-reading on a touchscreen display of the computing device, according to an embodiment.

FIG. 3 illustrates an example configuration for navigating content of an e-book via a start-reading interface for e-reading on a computer device having a touchscreen display, according to some embodiments.

FIG. 4 illustrates a method for navigating e-book content a start-reading interface for e-reading on a computer device having a touchscreen display, according to an embodiment.

### DETAILED DESCRIPTION

“E-books” area form of electronic publication content stored in digital format in a computer non-transitory memory, viewable on a computing device having display functionality. An e-book can correspond to, or mimic, the paginated format of a printed publication for viewing, such as provided by printed literary works (e.g., novels) and periodicals (e.g., magazines, comic books, journals, etc.). Optionally, some e-books may have chapter designations, as well as content that corresponds to graphics or images (e.g., such as in the case of magazines or comic books). Multi-function devices, such as cellular-telephony or messaging devices, can utilize specialized applications (e.g., specialized e-reading application software) to view e-books in a format that mimics the paginated printed publication. Still further, some devices (sometimes labeled as “e-readers”) can display digitally-stored content in a more reading-centric manner, while also providing, via a user input interface, the ability to manipulate that content for viewing, such as via discrete pages arranged sequentially (that is, pagination) corresponding to an intended or natural reading progression, or flow, of the content therein.

An “e-reading device”, variously referred to herein as an electronic personal display or mobile computing device, can refer to any computing device that can display or otherwise render an e-book. By way of example, e-reading device can include a mobile computing device on which an e-reading application can be executed to render content that includes e-books (e.g., comic books, magazines, etc.). Such mobile computing devices can include, for example, a multi-functional computing device for cellular telephony/messaging (e.g., feature phone or smart phone), a tablet computer device, an ultra-mobile computing device, or a wearable computing device with a form factor of a wearable accessory device (e.g., smart watch or bracelet, glass-wear integrated with a computing device, etc.). As another example, an e-reading device can include an e-reader device, such as a purpose-built device that is optimized for an e-reading experience (e.g., with E-ink displays).

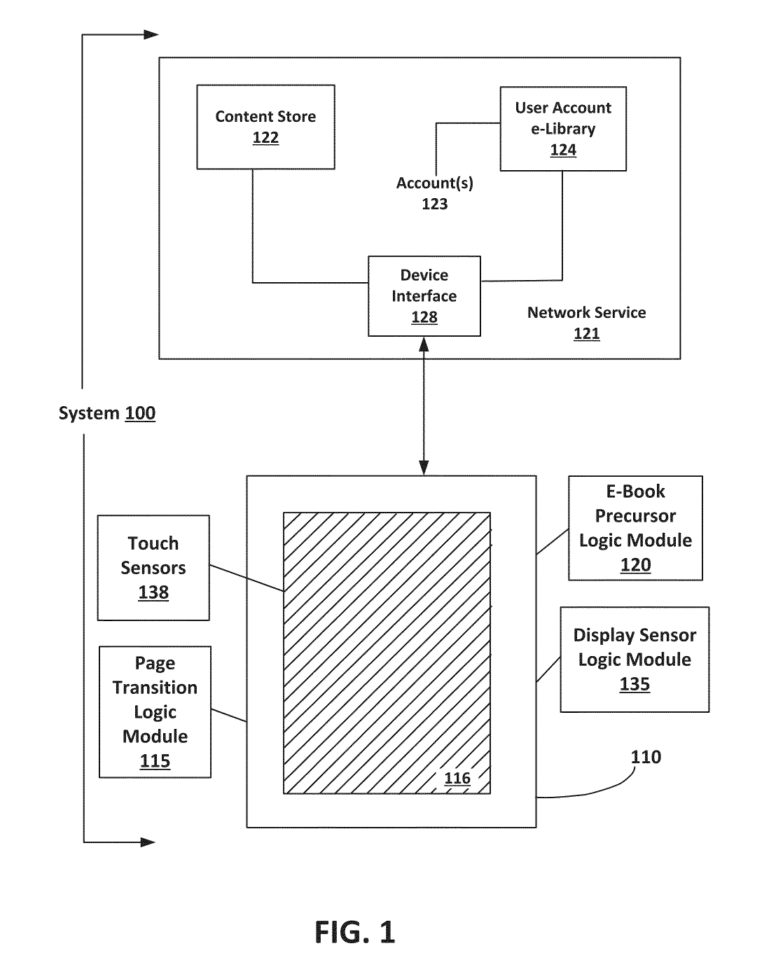

FIG. 1 illustrates a system 100 for utilizing applications and providing e-book services on a computing device configured for operation a start-reading interface for deployment on an e-reading device, according to an embodiment. In an example of FIG. 1, system 100 includes an electronic personal display device, shown by way of example as an e-reading device 110, and a network service 121. The network service 121 can include multiple servers and other computing resources that provide various services in connection with one or more applications that are installed on the e-reading device 110. By way of example, in one implementation, the network service 121 can provide e-book services that communicate with the e-reading device 110. The e-book services provided through network service 121 can, for example, include services in which e-books are sold, shared, downloaded and/or stored. More generally, the network service 121 can provide various other content services, including content rendering services (e.g., streaming media) or other network application environments or services.

The e-reading device 110 can correspond to any electronic personal display device on which applications and application resources (e.g., e-books, media files, documents) can be rendered and consumed. For example, the e-reading device 110 can correspond to a tablet or a telephony/messaging device (e.g., smart phone). In one implementation, for example, e-reading device 110 can run an e-reader application that links the device to the network service 121 and enables e-books provided through the service to be viewed and consumed by way of e-reading. In another implementation, the e-reading device 110 can run a media playback or streaming application that receives files or streaming data from the network service 121. By way of example, the e-reading device 110 can be equipped with hardware and software to optimize certain application activities, such as reading electronic content (e.g., e-books). For example, the e-reading device 110 can have a tablet-like form factor, although variations are possible. In some cases, the e-reading device 110 can also have an E-ink display.

In additional detail, the network service 121 can include a device interface 128, a content store server 122, and a user account electronic library (e-library) 124 storing e-books or digital content items. In some embodiments, content store server 122 and user account e-library may be implemented via server computing devices, as well as a server cloud computing system. Content store server 122 may be an online store for purchasing of digital content items for download therefrom onto a resident memory of an e-reading device 110 and/or user account e-library 124.

User account e-library 124 associates the e-reading device 110 with a user having user account 123. The user account 123 can also be associated with ownership of, and/or accessibility to, one or more digital content items stored in content store server 122. In one embodiment, the digital content items are e-books, and the content store server 122 is an online store having e-books for purchase or other licensed use. The device interface 128 can handle requests from the e-reading device 110 with regard to services and functionality of the network service 121. The device interface 128 can utilize information provided with user account 123 in order to enable services, such as purchasing and downloading of e-books into user account e-library 124, and determining what e-books and content items, such as those providable via content store server 122, are associated with, and accessible to, user account 123. Additionally, the device interface 128 can provide the e-reading device 110 with access to the on-line content store server 122. Device interface 128 can handle input to identify content items (e.g., e-books), and further to associate content items to recipient user account 123 of the user account e-library 124.

Yet further, content store server 122 and user account e-library 124 can retain metadata associated with e-books or other digital content items that have been purchased or made available for consumption via user account e-library 124. Thus, information relating to e-books within user account e-library 124 can include a metadata set in addition to substantive digital text and image content portions. The metadata set can include, for example, information such as the graphic representation of the e-book, such as including artwork- or image-based representation of a counterpart physical paper book cover, as well as summary information, author information, title, short synapse or book review, publication date and language of the e-book, and book or volume series information.

Additionally, information typically rendered within precursor pages of paper books, such as an epigraph, a biographical page of the author, a table of contents, a book review, a book dedication, a foreword, author acknowledgements, an introduction, and a copyright notice may correspondingly be provided by, and accessible from, the metadata of the e-book as electronically published. As used herein, the term precursor pages refers to the clustered pages of an e-book interposed between a displayed cover of the e-book and the actual substantive reading content within the e-book, providing information such as any or all of an epigraph, a biographical page of the author, a table of contents, a book review, a book dedication, a foreword, author acknowledgements, an introduction, and a copyright notice, and the like. The average e-book can typically feature a cluster of pages ranging from 3-15 precursor pages.

The e-reading device 110, may be associated with the recipient user account 123, and in fact multiple such display devices may be associated with a same account. As described in greater detail below, e-reading device 110 can locally store content items (e.g., e-books) that are purchased or otherwise made available to the user of the e-reading device 110 as well as to archive, within user e-library 124, e-books and other digital content items that have been purchased for the recipient user account 123, but are not necessarily stored in local resident memory at e-reading device 110.

With reference to an example of FIG. 1, e-reading device 110 can include a display screen 116. In an embodiment, display screen 116 is touch-sensitive, to process touch inputs including gestures (e.g., swipes). For example, display screen 116 may be integrated with one or more touch sensor components 138 to provide a touch-sensing region on a surface of display screen 116. For some embodiments, the one or more touch sensor components 138 may include capacitive sensors that can sense or detect a human body's capacitance as input. In the example of FIG. 1, the touch-sensing region coincides with a substantial surface area, if not all, of display screen 116. Additionally, the housing can be integrated with touch sensors to provide one or more touch sensing regions, for example, on the bezel and/or back surface of the housing.

In some embodiments, e-reading device 110 includes features for providing functionality related to displaying paginated e-book content, including paginated content comprising an e-magazine or e-comic book. E-reading device 110 can include page transition logic 115, which enables the user to transition through paginated content. E-reading device 110 can display pages of e-books, e-magazines and e-comics, and enable the user to transition from one page state to another. In particular, an e-book can provide content that is rendered sequentially in pages, and the e-book can display page states in the form of single pages, multiple pages or portions thereof Accordingly, a given page state can coincide with, for example, a single page, or two or more pages displayed at once. Page transition logic 115 can operate to enable the user to transition from a given page state to another page state In the specific example embodiment where a given page state coincides with a single page, for instance, each page state corresponding to one page of the digitally constructed series of pages paginated to comprise, in one embodiment, an e-book. In some implementations, page transition logic 115 enables single page transitions, chapter transitions, or cluster transitions (multiple pages at one time).

Page transition logic 115 can be responsive to various kinds of interfaces and actions in order to enable page transitioning. In one implementation, the user can signal a page transition event to transition page states by, for example, interacting with the touch-sensing region of display screen 116. For example, the user may swipe the surface of display screen 116 in a particular direction (e.g., up, down, left, or right) to indicate a backward or forward direction of page transition. In variations, the user can specify different kinds of page transitioning input (e.g., single page turns, multiple page turns, chapter turns, etc.) through different kinds of input. Additionally, a page turn input of the user can be provided according to a magnitude of the input action indicate a corresponding magnitude (number of pages) for the transition of the page state, For example, a user can touch and hold the surface of display screen 116 in order to cause a cluster or chapter page state transition, while a tap in the same region can only effect a single page state transition (e.g., from one page to the next in sequence). In another example, a user can specify page turns of different kinds or magnitudes through single taps, sequenced taps or patterned taps on the touch sensing region of display screen 116. Although discussed in context of “taps” herein, it is contemplated that a gesture action provided in sufficient proximity to touch sensors of display screen 116, without physically touching thereon, may also register as a “contact” with display screen 116, to accomplish a similar effect as a tap, and such embodiments are also encompassed by the description herein.

According to some embodiments, e-reading device 110 includes display sensor logic 135 to detect and interpret user input or user input commands made through interaction with touch sensor components 138. By way of example, display sensor logic 135 can detect a user making contact with the touch-sensing region of display screen 116, otherwise known as a touch event. More specifically, display sensor logic 135 can detect a touch events also referred to herein as a tap, an initial tap held in contact with display screen 116 for longer than some pre-defined threshold duration of time, otherwise known as a “long press” or a “long touch”, multiple taps performed either sequentially or generally simultaneously, swiping gesture actions made through user interaction with the touch sensing region of display screen 116, or any combination of these gesture actions. Although referred to herein as a “touch” or a tap, it should be appreciated that in some design implementations, sufficient proximity to the touchscreen surface, even in absence of actual physical contact, may register as a contact event or a touch event. Furthermore, display sensor logic 135 can interpret such interactions in a variety of ways. For example, each such interaction may be interpreted as a particular type of user input associated with a respective input command, execution of which may trigger a change in state of display screen 116.

In one implementation, display sensor logic 135 implements operations to monitor for the user contacting or superimposing upon, using a finger, thumb or stylus, a surface of display screen 116 coinciding with a placement of one or more touch sensor components 138, that is, a touch event, and also detects and correlates a particular gesture (e.g., pinching, swiping, tapping, etc) as a particular type of input or user action. Display sensor logic 135 may also sense directionality of a. user gesture action so as to distinguish between, for example, leftward, rightward, upward, downward and diagonal swipes along a surface portion of display screen 116 for the purpose of associating respective input commands therewith.

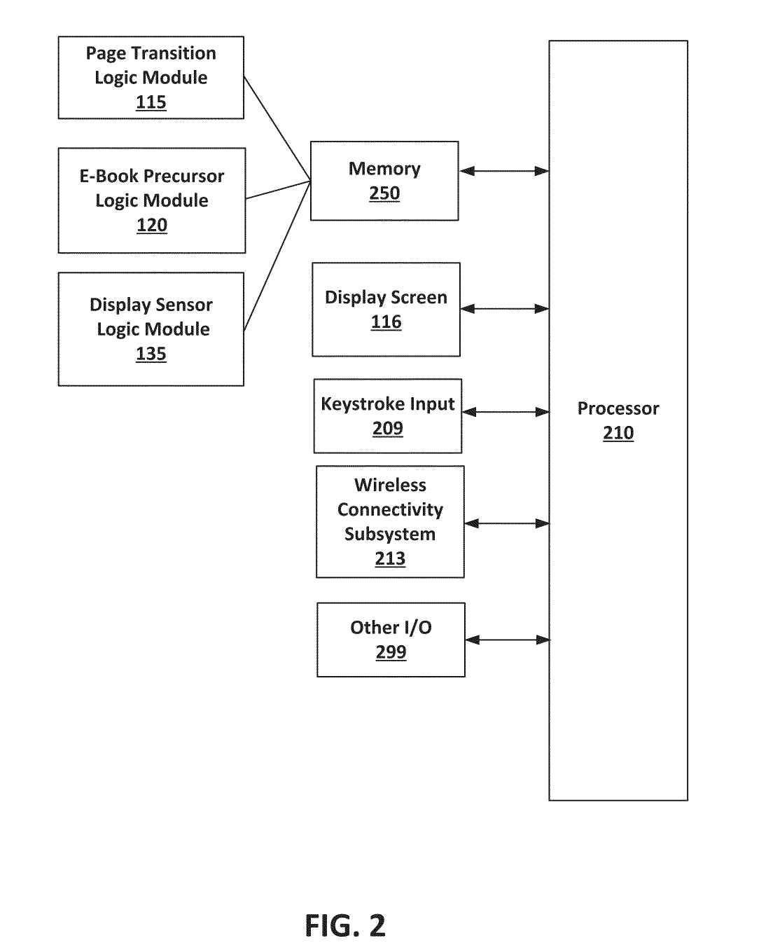

E-book precursor logic module 120, in one embodiment, includes logic to enable navigating content of an e-book via a start-reading interface for e-reading on e-reading device 110 device having touchscreen display, as will be described in further detail with regard to FIGS. 2-4.

One or more embodiments of e-book precursor logic module 120, display sensor logic 135 and page transition logic 115 described herein may be implemented using programmatic modules or components. A programmatic module or component may include a program, a subroutine, a portion of a program, or software or a hardware component capable of performing one or more stated tasks or functions in conjunction with one or more processors. As used herein, a module or component can exist on a hardware component independently of other modules or components. Alternatively, a module or component can be a shared element or process of other modules, programs and hardware components.

Furthermore, the one or more embodiments of e-book precursor logic module 120, display sensor logic 135 and page transition logic 115 described herein may be implemented through instructions that are executable by one or more processors. These instructions may be stored on a computer-readable non-transitory medium. In particular, the numerous computing and communication devices shown with embodiments of the invention include processor(s) and various forms of computer memory, including volatile and non-volatile forms, storing data and instructions. Examples of computer-readable mediums include permanent memory storage devices, such as hard drives on personal computers or servers. Other examples of computer storage mediums include portable storage units, flash or solid-state memory (such as included on many cell phones and consumer electronic devices) and magnetic memory. Computers, terminals, network enabled devices (e.g., mobile devices such as cell phones and wearable computers) are all examples of machines and devices that utilize processors, memory, and instructions stored on computer-readable mediums. Additionally, embodiments may be implemented in the form of computer-programs, or a computer usable storage medium capable of storing such a program.

FIG. 2 illustrates a schematic architecture and configuration of a e-reading device 110 configured for navigating e-book content via a start-reading interface for e-reading on the touch sensitive display screen 116 of the e-reading device 110, according to an embodiment.

E-reading device 110 further includes processor 210, a memory 250 storing instructions and logic pertaining at least to display sensor logic 135, e-book precursor logic module 120, and page transition logic 115.

Processor 210 can implement functionality using the logic and instructions stored in memory 250. Additionally, in some implementations, processor 210 communicates with the network service 121 (see FIG. 1). More specifically, e-reading device 110 can access the network service 121 to receive various kinds of resources (e.g., digital content items such as e-books, configuration files, account information), as well as to provide information (e.g., user account information, service requests etc.). For example, e-reading device 110 can receive application resources, such as e-books or media files, that the user elects to purchase or otherwise download via the network service 121. The application resources that are downloaded onto e-reading device 110 can be stored in memory 250.

In some implementations, display screen 116 can correspond to, for example, a liquid crystal display (LCD) or light emitting diode (LED) display that illuminates in order to provide content generated from processor 210. In some implementations, display screen 116 can be touch-sensitive. For example, in some embodiments, one or more of touch sensor components 138 may be integrated with display screen 116. In other embodiments, touch sensor components 138 may be provided (e.g., as a layer) above or below display screen 116 such that individual touch sensor components 138 track different regions of display screen 116. Further, in some variations, display screen 116 can correspond to an electronic paper type display, which mimics conventional paper in the manner in which content is displayed. Examples of such display technologies include electrophoretic displays, electro-wetting displays, and electro-fluidic displays.

Processor 210 can receive input from various sources, including touch sensor components 138, display screen 116, keystroke input 209 such as from a virtual or rendered keyboard, and other input mechanisms 299 (e.g., buttons, mouse, microphone, etc.). With reference to examples described herein, processor 210 can respond to input detected at touch sensor components 138. In some embodiments, processor 210 responds to inputs from touch sensor components 138 in order to facilitate or enhance e-book activities such as generating e-book content on display screen 116, performing page transitions of the displayed e-book content, powering off e-reading device 110 and/or display screen 116, activating a screen saver, launching or closing an application, and/or otherwise altering a state of display screen 116.

In some embodiments, memory 250 may store display sensor logic 135 that monitors for user interactions detected through touch sensor components 138, and further processes the user interactions as a particular input or type of input. In an alternative embodiment, display sensor logic 135 may be integrated with touch sensor components 138. For example, touch sensor components 138 can be provided as a modular component that includes integrated circuits or other hardware logic, and such resources can provide some or all of display sensor logic 135. In variations, some or all of display sensor logic 135 may be implemented with processor 210 (which utilizes instructions stored in memory 250), or with an alternative processing resource.

E-reading device 110 further includes wireless connectivity subsystem 213, comprising a wireless communication receiver, a transmitter, and associated components, such as one or more embedded or internal antenna elements, local oscillators, and a processing module such as a digital signal processor (DSP) (not shown). As will be apparent to those skilled in the field of communications, the particular design of wireless connectivity subsystem 213 depends on the communication network in which e-reading device 110 is intended to operate, such as in accordance with Wi-Fi, Bluetooth, Near Field Communication (NFC) communication protocols, and the like.

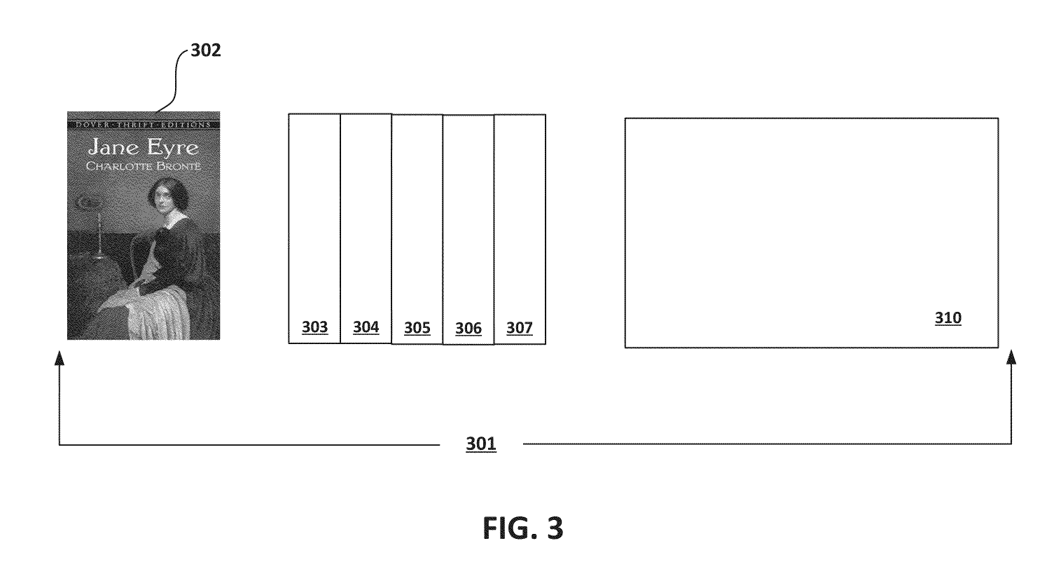

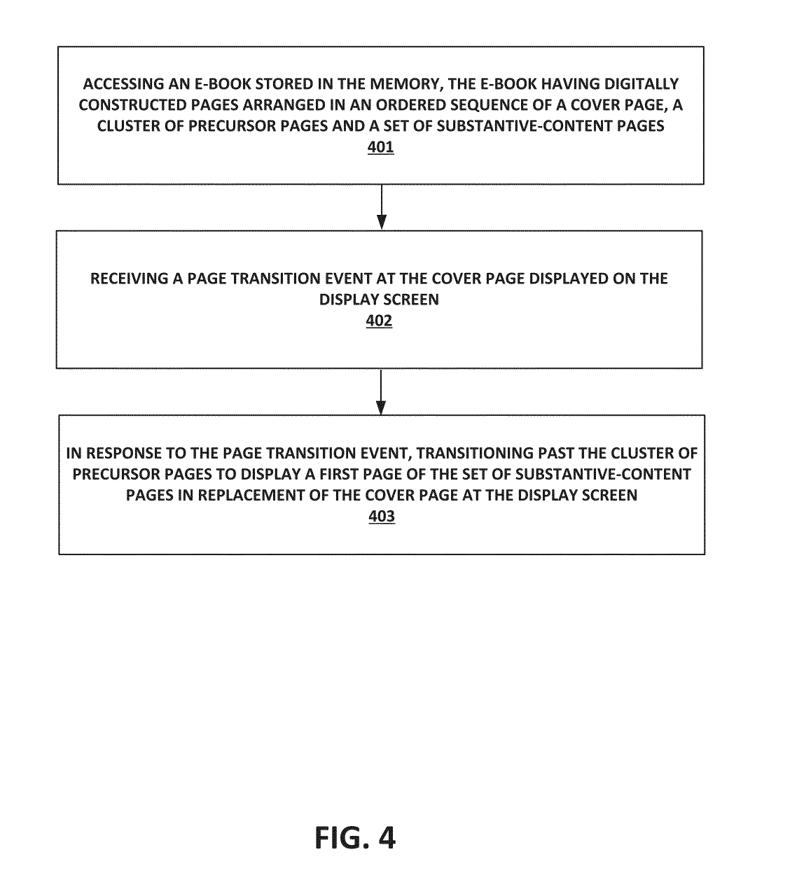

E-book precursor logic module 120, in one embodiment, provides an interface for navigating content of the e-book after notifying a user at display screen 116 of e-reading device 110, that a given ebook accessed by computing device 110 has an identifiable cluster of precursor pages, and further require from the user an assenting action before taking action with regard to the cluster of precursor pages, as will be described further in further detail with regard to FIGS. 3 and 4. Yet further, e-book precursor logic module 120 may function to interpret a given user input touch gesture differently when performed on different sections of the e-book, as will be described with reference to FIG. 3. In general, the cluster of precursor pages can include, but is not limited to, a title page, a biographical page, a table of contents page, a book review page, a dedication page, a foreword page, an acknowledgement page, an epigraph page, an introduction page, a copyright page, and the like.

E-book precursor logic module 120 can be implemented as a software module, comprising instructions stored in memory 250, on e-reading device 110. One or more embodiments of e-book precursor logic module 120 described herein may be implemented using programmatic modules or components, a portion of a program, or software in conjunction with one or more hardware component(s) capable of performing one or more stated tasks or functions. As used herein, such module or component can exist on a hardware component independently of other modules or components. Alternatively, a module or component can be a shared element or process of other modules, programs or machines.

FIG. 3 illustrates a schematic configuration of e-book enabling navigating of content therein via a start-reading interface for e-reading on e-reading device 110 having a touch sensitive display screen 116, according to an embodiment. E-book 301 comprises digitally constructed pages arranged in an ordered sequence of the pages. In an embodiment, the sequence of pages may be grouped into a cover page 302, a cluster of precursor pages 303-307, and a set of substantive reading content pages 310 for reading.

Still with reference to FIG. 3, cover page 302 as displayed on display screen 116 of e-reading device 110 may include artwork, graphics, text and a title mimicking the cover of a corresponding paper book as published, and as may be made available for display on a retail shelf The duster of precursor pages 303-307 a typical e-book may range anywhere from 3-15 pages in individual page count as rendered when e-reading display screen 116. The set of substantive reading content pages 310 comprises a significant majority of the e-book content for reading, and accounts for 90% or more of the page count of the typical e-book.

Via e-book precursor logic module 120, when a user at display screen 116 of e-reading device 110 accesses a given e-book, either at local memory 250 or remotely via user account e-library 124 server computing device, cover page 302 is displayed, and a notification may be provided advising of an identifiable cluster of precursor pages 303-307 within the accessed e-book content. Further, a solicitation may be provided within the notice, asking whether the user assents to using an optional start-reading interface for e-reading the e-book. If the user assents, then, upon enacting a page transition command at the touch sensitive display screen 116, such as a swipe gesture upon displayed cover page 302, the display view transitions past the next in sequence pages of the cluster of precursor pages 303-307, with a result that a first page of substantive reading content pages 310, typically a first page of a Chapter 1 of the e-book, is rendered on display screen 116.

In one embodiment of e-book precursor logic module 120, a given user input touch gesture may be interpreted differently by processor 210 to achieve a different interface result when performed on different sections of the e-book. In particular, whereas when a swipe gesture action enacted upon a page of substantive-content pages 310 causes a single-page transition, that same swipe gesture action when performed upon cover page 302 rendered on display screen 116 causes the unexpectedly different result of transitioning past the precursor pages cluster 303-307 directly to a first page in the sequence of pages contained in substantive-content pages 310, allowing the user can start e-reading directly from that page. It is contemplated that various touchscreen gestures may be applied for these purposes, such as a long press, a multi-point sequence of taps, and multiple simultaneous taps upon display screen 116 over rendered e-book content.

In another variation, in lieu of presenting a notification at e-book cover page 302 requiring a user's assent before applying the start-reading interface described herein, it is contemplated that a user preference for automatic invocation may be enabled via a device setting at e-reading device 110.

Next with reference to FIG. 4, illustrated is a method for providing a start-reading interface for e-reading on e-reading device 110 having a touchscreen type display screen 116, according to an embodiment. In describing the example of FIG. 4, reference will be made to components such as described with regard to FIGS. 1 through 3 for purposes of illustrating components for performing a step or sub-step as described.

At step 401, access an e-book 301 stored in the memory 250, the e-book 301 having digitally constructed pages arranged in an ordered sequence of a cover page 302, a cluster of precursor pages 303-307, and a set of substantive-content pages 310.

At step 402, receiving a page transition event at the cover page 302 displayed on the display screen 116 of e-reading device 110.

At step 403, in response to the page transition event, transitioning past the cluster of precursor pages 303-307 to display a first page of the set of substantive-content pages 310 in replacement of the cover page 302 at the display screen 116 of e-reading device 110.

Although illustrative embodiments have been described in detail herein with reference to the accompanying drawings, variations to specific embodiments and details are contemplated and encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A method executed in a processor of a computing device, the computing device further including a memory storing instructions and a display screen having touch sensing functionality, the method comprising:
accessing an e-book stored in the memory, the e-book having digitally constructed pages arranged in an ordered sequence of a cover page, a cluster of precursor pages and a set of substantive-content pages;
receiving a page transition event at the cover page displayed on the display screen; and
in response to the page transition event, transitioning past the cluster of precursor pages to display a first page of the set of substantive-content pages in replacement of the cover page at the display screen.

2. The method of claim 1, whereupon accessing the e-book in memory, presenting a notification at the display screen that the e-book is identified as having a cluster of precursor pages.

3. The method of claim 2 wherein the notification further solicits performance of an assent action at the display screen prior to transitioning past the cluster of precursor pages.

4. The method of claim 1 wherein the cluster of precursor pages is identified from metadata of the e-book as electronically published.

5. The method of claim 1 wherein the page transition event comprises a touch event.

6. The method of claim 5 wherein the touch event is one of: a swipe, a long press, a multi-point tap, and a series of taps.

7. The method of claim 1 wherein the cluster of precursor pages consists of at least one of: a title page, an epigraph, a biographical page, a table of contents, a book review page, a dedication page, a foreword, an acknowledgement page, an introduction page, and a copyright notice.

8. The method of claim 7 wherein the first page of the set of substantive-content pages is entitled Chapter 1.

9. The method of claim 1 wherein the step of transitioning past the cluster of precursor pages is performed only if a start-reading device setting is enabled.

10. The method of claim 1 wherein the page transition event accomplishes a single page transition when enacted at one of: a precursor page in the cluster of precursor pages and a substantive-content page within the set of substantive-content pages.

11. A computer-readable medium that stores instructions for a computing device, the computing device including a processor, a memory and a display screen having touch sensing functionality, the instructions being executable by the processor to cause the computing device to perform operations that include:
accessing an e-book stored in the memory, the e-book having digitally constructed pages arranged in an ordered sequence of a cover page, a cluster of precursor pages and a set of substantive-content pages;
receiving a page transition event at the cover page displayed on the display screen; and
in response to the page transition event, transitioning past the cluster of precursor pages to display a first page of the set of substantive-content pages in replacement of the cover page at the display screen.

12. A computing device comprising:
a memory that stores a set of instructions;
a display screen having touch sensing functionality;
a processor that access the instructions in memory, the processor further configured to:
access an e-book stored in the memory, the e-book having digitally constructed pages arranged in an ordered sequence of a cover page, a cluster of precursor pages and a set of substantive-content pages;
receive a page transition event at the cover page displayed on the display screen; and
in response to the page transition event, transition past the cluster of precursor pages to display a first page of the set of substantive-content pages in replacement of the cover page at the display screen.

13. The computing device of claim 12 whereupon accessing the e-book in memory, presenting a notification at the display screen that the e-book is identified as having a cluster of precursor pages.

14. The computing device of claim 13 wherein the notification further solicits performance of an assent action at the display screen prior to transitioning past the cluster of precursor pages.

15. The computing device of claim 12 wherein the cluster of precursor pages is identified from metadata of the e-book as electronically published.

16. The computing device of claim 12 wherein the page transition event comprises a touch event.

17. The computing device of claim 16 wherein the touch event is one of: a swipe, a long press, a multi-point tap, and a series of taps.

18. The computing device of claim 12 wherein the cluster of precursor pages consists of at least one of: a title page, a biographical page, a table of contents page, a book review page, a dedication page, a foreword page, an acknowledgement page, an epigraph page, an introduction page, and a copyright page.

19. The computing device of claim 12 wherein the step of transitioning past the cluster of precursor pages is performed only if a start-reading device setting is enabled.

20. The computing device of claim 12 wherein the page transition event accomplishes a single page transition when enacted at one of: a precursor page in the cluster of precursor pages and a substantive-content page within the set of substantive-content pages.
